(19) United States
(12) Patent Application Publication
(10) Pub. No.: US 2014/0313362 A1
(43) Pub. Date: Oct. 23, 2014

(54) METHOD AND DEVICE RELATING TO IMAGE CONTENT

(71) Applicant: Sony Mobile Communications AB, Lund (SE)

(72) Inventor: Henrik Heringslack, Malmo (SE)

(73) Assignee: SONY MOBILE COMMUNICATIONS AB, Lund (SE)

(21) Appl. No.: 13/807,819

(22) PCT Filed: Feb. 22, 2012
(86) PCT No.: PCT/EP12/52985

§ 371 Date: May 2, 2013

(51) Int. Cl. H04N 5/232; G06F 17/24

(52) U.S. Cl. CPC H04N 5/23293; G06F 17/24
USPC 348/222.1

(57) ABSTRACT

The invention relates to a method and device for reproducing an image. The device comprises: a controller and an image recording portion for recording a first image comprising a first object and a second object, means for computing distance data to each of said first and second objects; and the controller being configured to generate output image data for a second image, said output image data comprising distance data to said first and second objects and data for additional visual information, wherein said additional visual information together with at least a first portion of said second image when reproduced is visualised different than at least a second portion of said second image with respect to distance information from said computed distance.

### TECHNICAL FIELD

The present invention relates to image processing in general and providing reproduced images with relevant information with respect to image object features, especially image depth.

### BACKGROUND

Present, portable devices, such as mobile phones equipped with a camera, PDA, digital camera, etc. allow displaying visual information with high resolution.

When viewing augmented reality (AR) through a display, e.g. camera or computer display, a large amount of information may be reproduced on the screen in all depths. A legacy camera does not generate a depth map that can pinpoint certain depth or distances. The depth and distance can however be used to select AR information that can be visible.

### SUMMARY

One object of the present invention provides a method and device for solving problem of providing a reproduced image with additional information with respect to image depth based on the distance to objects in the image.

For this reason, a device is provided for reproducing an image, the device comprising: a controller and an image recording portion for recording a first image comprising a first object and a second object. The device further comprises means for computing distance data to each of the first and second objects; and the controller is configured to generate output image data for a second image. The output image data comprising distance data to the first and second objects and data for additional visual information. The additional visual information together with at least a first portion of the second image when reproduced is visualised different than at least a second portion of the second image with respect to distance information from the computed distance. The different visualisation comprises different visualisation characteristics having less or more detail, sharpness, or contrast than the first portion when reproduced. The image recording portion may comprise one or several of: a depth camera, a stereographic camera, a computational camera, a ranging camera, a flash lidar, a time-of-flight (ToF) camera, or RGB-D cameras using different sensing mechanisms being of: range-gated ToF, Radio Frequency modulated ToF, pulsed-light ToF, and projected-light stereo. In one embodiment the image recording portion measures an actual distance to the object. In one embodiment the image recording portion comprises an autofocus, providing data for focused parts of the recorded image which is interpreted as distance data. In one embodiment the device comprises means for providing the second the reproduction is executed externally on an external display. The controller may be configured to produce a depth map in a viewfinder and the device is configured to sort additional information to be viewed and set a details grade in the information to be reproduced.

The invention also relates to a method of providing a reproduced image with additional information. The method comprises: using an a digital image, comprising a first and a second object and comprising data identifying a distance to the first and second object, producing an output image data comprising the additional information linked to the first and second object, the output image data reproducing the image with inserted additional information and different visibility parameters with respect to the different distances. The different visibility parameters comprise different visualisation characteristics having less or more detail, sharpness, or contrast than the first portion when reproduced. The method may further comprise producing a depth map in a viewfinder and sorting additional information to be viewed and set a details grade in the information to be reproduced.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 illustrates a schematic view of a camera device according to a first embodiment of the invention,

FIG. 3 illustrates a schematic view of a camera device according to a second embodiment of the invention,

FIG. 4 illustrates a schematic view of a camera device according to a third embodiment of the invention,

FIGS. 5a and 5b illustrate schematically a display of a device showing images in two different focusing modes according to one embodiment of the present invention; and

FIG. 6 illustrates a schematic view of steps of a method according to the invention.

### DETAILED DESCRIPTION

The following detailed description refers to the accompanying drawings. The same reference numbers in different drawings may identify the same or similar elements. The term “image,” as used herein, may refer to a digital or an analog representation of visual information (e.g., a picture, a video, a photograph, animations, etc.).

Also, the following detailed description does not limit the invention. Instead, the scope of the invention is defined by the appended claims and equivalents.

According to the invention, generally when having continuous generated depth map in viewfinder the device is configured to sort out what AR information to be viewed and the details grade in the information can be set.

By using field of view and setting focus on a depth map generated picture in viewfinder, the system detects what distance that is in focus. Using this information, AR information can be generated “naturally”. In the focused field of view area more details can be provided with augmented reality. Objects closer or further away can have different visualization characteristics, such as blurred out, unfocused, grayed etc., in same way as the picture. In the blurred out parts of the picture less details are shown. By changing the focus area, the blurred parts will become sharp and additional information is shown.

The terms “augmented reality”, “additional information” or “mediated reality”, as used herein, generally relates to modifying an image, e.g. by a computer, by adding additional features such as sound, video, graphics or GPS data, etc.

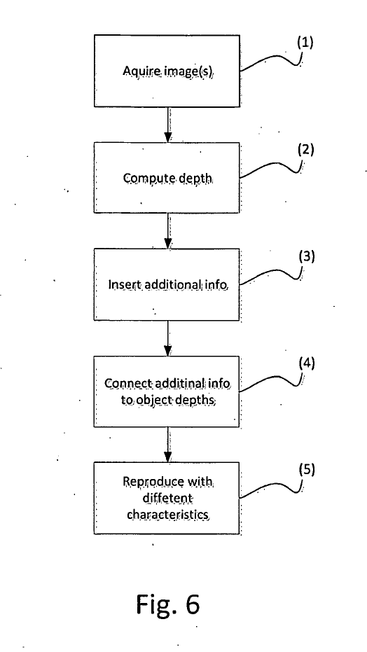

FIG. 6 illustrates the method steps according to one embodiment:

An image is acquired (1), as will be described in the following description, depth of the image or distance to objects in the image are computed (2), additional information data is inserted (3) and linked (4) to objects and an output image is reproduced (5) with the additional information having different visibility parameters with respect to the different distances.

The method of claim 8, wherein said different visibility parameters comprises different visualisation characteristics having less or more detail, sharpness, or contrast than said first portion when reproduced.

The method of claim 8, further comprising producing a depth map in a viewfinder and sorting additional information to be viewed and set a details grade in the information to be reproduced.

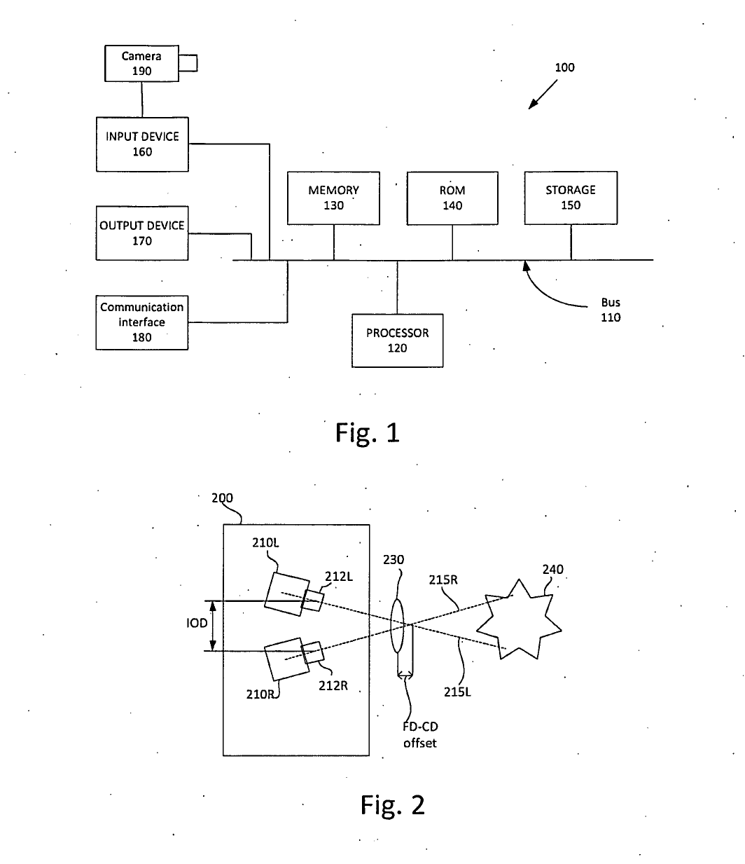

FIG. 1 is a diagram of an exemplary system 100 in which methods and systems described herein may be implemented. System 100 may include a bus 110, a processor 120, a memory 130, a read only memory (ROM) 140, a storage device 150, an input device 160, an output device 170, and a communication interface 180. Bus 110 permits communication among the components of system 100. System 100 may also include one or more power supplies (not shown). One skilled in the art would recognize that system 100 may be configured in a number of other ways and may include other or different elements.

Processor 120 may include any type of processor or microprocessor that interprets and executes instructions. Processor 120 may also include logic that is able to decode media files, such as audio files, video files, multimedia files, image files, video games, etc., and generate output to, for example, a speaker, a display, etc. Memory 130 may include a random access memory (RAM) or another dynamic storage device that stores information and instructions for execution by processor 120. Memory 130 may also be used to store temporary variables or other intermediate information during execution of instructions by processor 120.

ROM 140 may include a conventional ROM device and/or another static storage device that stores static information and instructions for processor 120. Storage device 150 may include a magnetic disk or optical disk and its corresponding drive and/or some other type of magnetic or optical recording medium and its corresponding drive for storing information and instructions. Storage device 150 may also include a flash memory (e.g., an electrically erasable programmable read only memory (EEPROM)) device for storing information and instructions.

Input device 160 may include one or more conventional mechanisms that permit a user to input information to the system 100, such as a keyboard, a keypad, a directional pad, a mouse, a pen, voice recognition, a touch-screen and/or biometric mechanisms, etc. The input device may be connected to an image recorder, such as a camera device 190 for still or motion pictures.

Output device 170 may include one or more conventional mechanisms that output information to the user, including a display, a printer, one or more speakers, etc. Communication interface 180 may include any transceiver-like mechanism that enables system 100 to communicate with other devices and/or systems. For example, communication interface 180 may include a modem or an Ethernet interface to a LAN.

Alternatively, or additionally, communication interface 180 may include other mechanisms for communicating via a network, such as a wireless network. For example, communication interface may include a radio frequency (RF) transmitter and receiver and one or more antennas for transmitting and receiving RF data.

System 100, consistent with the invention, provides a platform through which a user may obtain access to view various media, such as video files or image files, and also games, multimedia files, etc. System 100 may also display information associated with the media played and/or viewed by a user of system 100 in a graphical format, as described in detail below.

According to an exemplary implementation, system 100 may perform various processes in response to processor 120 executing sequences of instructions contained in memory 130. Such instructions may be read into memory 130 from another computer-readable medium, such as storage device 150, or from a separate device via communication interface 180. It should be understood that a computer-readable medium may include one or more memory devices or carrier waves. Execution of the sequences of instructions contained in memory 130 causes processor 120 to perform the acts that will be described hereafter. In alternative embodiments, hard-wired circuitry may be used in place of or in combination with software instructions to implement aspects consistent with the invention. Thus, the invention is not limited to any specific combination of hardware circuitry and software.

According to a first embodiment of the camera device, it may be a stereographic camera 200. Referring now to FIG. 2, a stereographic camera 200 may include a left camera 210L and a right camera 210R. The term “camera” is intended to include any device having an optical system to form an image of an object and a medium to receive and detect and/or record the image. The left and right cameras may be film or digital still image cameras, may be film or digital motion picture cameras, or may be video cameras. The left and right cameras 210L, 210R may be separated by an interocular distance IOD. Each of the left and right cameras 210L, 210R may include a lens 212L, 212R. The term “lens” is intended to include any image-forming optical system and is not limited to combinations of transparent refractive optical elements. A lens may use refractive, diffractive, and/or reflective optical elements and combinations thereof. Each lens may have an axis 215L, 215R that defines the centre of the field of view of each camera 210L, 210R.

The cameras 210L, 210R may be disposed such that the axis 215L, 215R are parallel or such that a convergence angle—is formed between the two axis 215L, 215R. The cameras 210L, 210R may be disposed such that the axis 215L, 215R cross at a convergence distance CD from the cameras. The interocular distance IOD, the convergence distance CD, and the convergence angle a are related by the formula

α=2 A TAN(IOD/2CD), or (1)

CD=IOD/[2 TAN(α/2)]. (2)

The interocular distance IOD and the convergence distance CD may be measured from a nodal point, which may be the centre of an entrance pupil, within each of the lenses 212L, 212R. Since the entrance pupils may be positioned close to the front of the lenses 212L, 212R, the interocular distance IOD and the convergence distance CD may be conveniently measured from the front of the lenses 212L, 212R.

The stereographic camera 200 may be used to form a stereographic image of a scene. As shown in the simplified example of FIG. 2, the scene may include a primary subject 230, which is shown, for example a person. The scene may also include other features and objects in the background (behind the primary subject). The distance from the cameras 210L, 210R to the furthest background object 240, which is shown, for example a tree, may be termed the extreme object distance EOD.

When the images from a stereographic camera, such as the stereographic camera 200, are displayed on a viewing screen, scene objects at the convergence distance will appear to be in the plane of the viewing screen. The primary subject 230 is located closer to the stereographic camera may appear to be in front of the viewing screen. The object 240, located further from the stereographic camera, may appear to be behind the viewing screen.

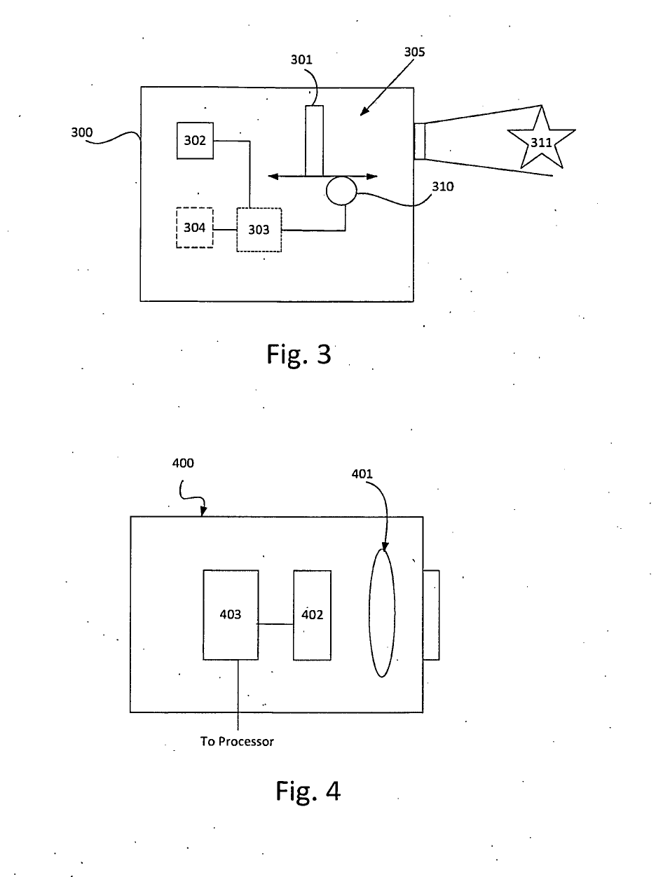

A second embodiment of the camera device is illustrated schematically in FIG. 3, in which the elements which make up a typical passive autofocus system for a camera device 300 are illustrated. The camera device 300 includes a lens 301 (which may be a compound lens), a sensor 302 (such as a pixel array), a motor 310 for moving the lens so as to change the focal length of the system, and a microprocessor 303 with associated memory 304. The processor 303 may be the processor 120 and memory 304 the RAM memory, as mentioned earlier. The motor and the leans comprise the focus and plane adjustment means 305. The plane adjustment means may form part of an image stabilization system. The plane adjustment means may, for example, comprise means to tilt the lens.

The processor is operable to control the focus means and plane adjustment means so as to automatically focus on a subject 311 in the field of view of the camera device by setting the focal length of the camera device successively at one or more focal positions while an angle of the focus plane is tilted so as not to be orthogonal to the optical path. The camera device may further be operable to take an image at each of the focal positions and to perform a comparison of data from each image so as to determine best focus. The comparison includes comparing data from at least two different locations along the tilted focus plane of at least one of the images. The comparison may comprise data from at least two different locations on the tilted focus plane for each image taken. The number of locations compared from each image may be the same for each of the images.

At least some of the locations from which data is taken for the comparison may each define a region of interest, and the camera device performs the comparison over each region of interest. The regions of interest may comprise a line perpendicular to the axis of tilt of the tilted focus plane, substantially centred in the field of view. The data for comparison comprises image contrast or sharpness statistics which may be interpreted to distance data, which are stored and used for carrying out the invention.

In a third embodiment of the camera device the data from an autofocus function may be used. FIG. 4 illustrates schematically a camera 400 comprising a lens 401, a sensor (e.g. CCD sensor) 402, and an autofocus device 403. Each time the autofocus device tries to focus on an object, the data is provided to the controller 120 and thus the data corresponding to a blur object (part of image) is stored. This data may constitute the data used for AR depth according to the invention.

In yet another embodiment, a computational camera may be used, which uses a combination of optics and computations to produce the final image. The optics is used to map rays in the light field of a scene to pixels on a detector. The ray may geometrically be redirected by the optics to a different pixel from the one it would have arrived. The ray may also be photo-metrically changed by the optics. In all cases, the captured image is optically coded. A computational module has a model of the optics, which it uses to decode the captured image to produce a new type of image that could benefit a vision system.

Other depth cameras, such as ranging camera, flash lidar, time-of-flight (ToF) camera, and RGB-D cameras using different sensing mechanisms such as: range-gated ToF, RF-modulated ToF, pulsed-light ToF, and projected-light stereo may also be used. The commonality is that all may provide traditional (sometimes color) images and depth information for each pixel (depth images).

Another technique that may be used is parallax scanning depth enhancing imaging method, which may rely on discrete parallax differences between depth planes in a scene. The differences are caused by a parallax scan. When properly balanced (tuned) and displayed, the discrete parallax differences are perceived by the brain of a viewer as depth. The depth map data may be acquired for purpose of the invention.

Thus, the invention uses information from above described embodiments of the camera device to generate AR or mediate reality information. In the focused field of view area more details are provided with augmented reality. Objects closer or further away are be blurred out in same way as the picture. In the blurred out parts of the picture less details are shown. By changing the focus area, the blurred parts now get sharp and additional information is shown.

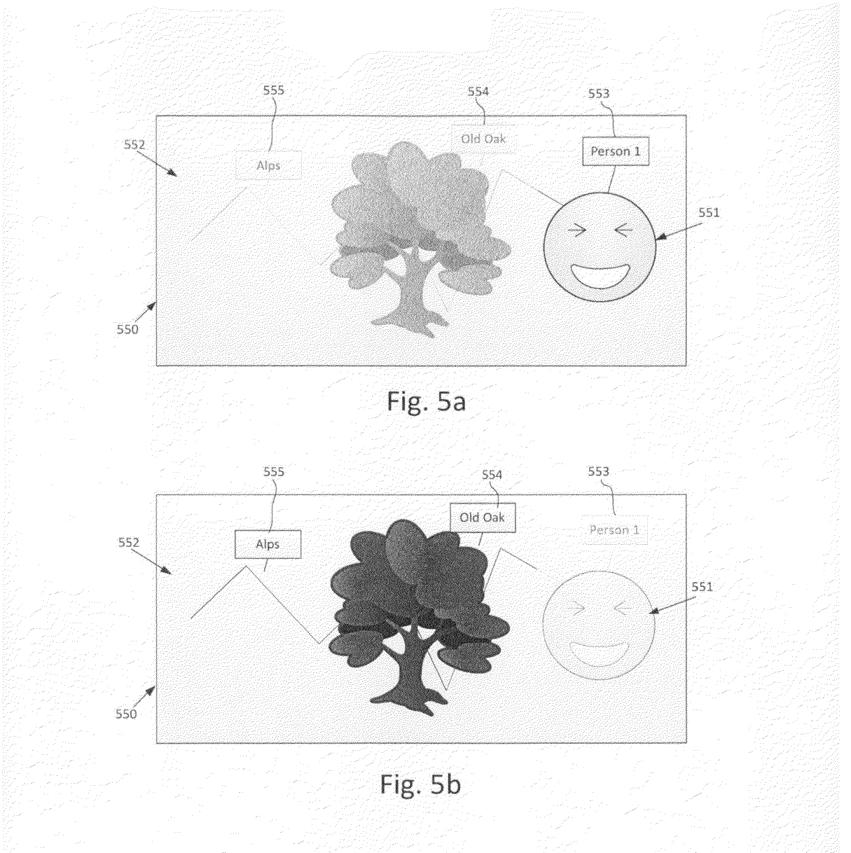

FIGS. 5a and 5b illustrate one example of a display 550 showing an image, including a person's face 551, with a landscape 552 in background. The AR information, in this case formed as tags 553-555 are provided in the displayed image. The tag 553, may be the name of the face: “Person 1”, the tag 554 shows a tree, may be the famous “Old Oak” and the tag 555 informs about the mountain in the background, which is the “Alps”.

In FIG. 5a, as the focus of the camera is on the face, the tag 553 of the face together with the face 551 is not blurred. In FIG. 5b, however, the focus is on the background, i.e. the mountains and the tree, and thus the face 551 and the tag 553 is blurred, while tags 554 and 555 are visualized clearly.

The image and information may also be reproduced later on another device, such as a computer, by transferring information from the camera device to the computer.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

The various embodiments of the present invention described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What we claim is:

1. A device for reproducing an image, the device comprising:
a controller;
an image recording portion for recording a first image comprising a first object and a second object;
an arrangement for computing distance data to each of said first and second objects;
the controller being configured to:
generate output image data for a second image, said output image data comprising a distance data to said first and second objects and data for additional visual information, wherein said additional visual information together with at least a first portion of said second image when reproduced is visualised different visibility than at least a second portion of said second image with respect to distance information from said computed distance.

2. The device of claim 1, wherein said different visualisation comprises different visualisation characteristics having less or more detail, sharpness, or contrast than said first portion when reproduced.

3. The device of claim 1, wherein said image recording portion comprises one or several of: a depth camera, a stereographic camera, a computational camera, a ranging camera, a flash lidar, a time-of-flight (ToF) camera, or RGB-D cameras using different sensing mechanisms being of: range-gated ToF, Radio Frequency modulated ToF, pulsed-light ToF, and projected-light stereo.

4. The device of claim 1, wherein said image recording portion measures an actual distance to the object.

5. The device of claim 1, wherein said image recording portion comprises an autofocus, providing data for focused parts of the recorded image which is interpreted as distance data.

6. The device of claim 1, comprising means for providing said second said reproduction is executed externally on an external display.

7. The device of claim 1, wherein the controller is configured to produce a depth map in a viewfinder and the device is configured to sort additional information to be viewed and set a details grade in the information to be reproduced.

8. A method of providing a reproduced image with additional information, the method comprising:
in a digital image, comprising a first and a second object and comprising data identifying a distance to said first and second object,
producing an output image data comprising said additional information linked to said first and second object, said output image data reproducing said image with inserted additional information and different visibility grade parameters with respect to said different distances.

9. The method of claim 8, wherein said different visibility parameters comprises different visualisation characteristics having less or more detail, sharpness, or contrast than said first portion when reproduced.

10. The method of claim 8, further comprising producing a depth map in a viewfinder and sorting additional information to be viewed and set a details grade in the information to be reproduced.
